(19) United States
(12) Patent Application Publication
(10) Pub. No.: US 2013/0187088 A1
(43) Pub. Date: Jul. 25, 2013

(54) COMPOSITION FOR RESTORATION OF IMMERSION DAMAGED PERSONAL MICROELECTRONICS DEVICE

(71) Applicant: Illnois Tool Works, Inc., Glenview, IL (US)

(72) Inventors: Karen S. Mertins, Lawrenceville, GA (US); Edward B. Williams, Conyers, GA (US)

(73) Assignee: Illinois Tool Works, Inc., Glenview, IL (US)

(21) Appl. No.: 13/746,159

(22) Filed: Jan. 21, 2013

Related U.S. Application Data
(60) Provisional application No. 61/588,283, filed on Jan. 19, 2012.

(51) Int. Cl. B01D 12/00

(52) U.S. Cl. CPC B01D 12/00
USPC 252/194

(57) ABSTRACT

A water displacing composition is provided that includes a C₄-C₉ hydrocarbon that is linear, branched or cyclic. The hydrocarbon represents the majority constituent of the composition. A C₃-C₆ alcohol is also present. The composition is well suited for displacing water from circuitry in a personal electronic device that has been inadvertently wet. An anti-corrosion agent is provided to inhibit corrosion associated with residual water remaining in contact with the circuitry after exposure to the composition. The process for restoring operation to a personal electronic device having circuitry that has been wet by water includes exposing the circuitry to the composition through spraying, immersion, or other techniques.

### RELATED APPLICATIONS

This application claims prior benefit of U.S. Provisional Application Ser. No. 61/588,283 filed Jan. 19, 2012; the contents of which are hereby incorporated by reference.

### FIELD OF THE INVENTION

The present invention in general relates to a water displacing composition and a process for the use thereof, and in particular, to restore function to microelectronics especially those containing displayed components.

### BACKGROUND OF THE INVENTION

With the commonplace usage of personal microelectronics device and their portable nature, accidental exposure of such devices to water and everyday aqueous based solutions has become commonplace through inadvertent washing, droppage into wash basins, and simply being displaced and being exposed to high ambient moisture. Most often, exposure of these personal microelectronics to moisture is fatal to their performance either through an immediate short circuiting or through corrosion which follows thereafter. In recognition of these dangers, a field of thought in the prior art seeks to prevent moisture infiltration through resort to some form of barrier film as exemplified for an external waterproof case (U.S. Pat. No. 7,180,735) or an internal barrier (U.S. Pat. No. 5,896,453). While such barriers are obviously effective in precluding moisture exposure, these barriers impede device operation and as a result have met with limited acceptance.

Yet another type of prior art attempts to restore the function to cell phones that have been exposed to water immersion. These techniques have included placing the immersed cell phone into a sealed desiccant pouch, or a device disassembly followed by a spray application of a water displacing composition. However, these techniques have met with limited acceptance owing to the long duration of about 72 hours, and the requirement of disassembly, respectively to restore cell phone operation. A variety of anecdotal recommendations for restoring cellular telephone function after water immersion are generally ineffective and often irreversibly damage the cellular telephone. Exemplary of these anecdotal recommendations include usage of a hair dryer, vacuum cleaner, heat lamp or other irradiative heating process to induce physical evaporation of the water over a period of time. Other anecdotal recommendations include usage of silica gel or uncooked rice as desiccants to draw water from the previously immersed device. These anecdotal recommendations are not only slow to operate but even if effective, leave the device vulnerable to corrosion associated with residual moisture retained within the device. Additionally, rinsing or immersion of the device in a water displacing solvent such as neat isopropanol while rapidly displacing water can damage internal components especially those associated with display and device auditory functions. Representative of usage of these teachings is through butyloctyl alcohols inclusive of a rust inhibitor, such as those found in U.S. Pat. No. 2,647,839. While these formulations are well suited for marine salvage of electric motors, the water displacing alcohols tend to damage polymeric layers associated with personal microelectronic devices and in particular films associated with device transparent displays.

Thus, there exists a need for a composition and process for the use thereof to restore function to a microelectronic device that has been immersed or otherwise detrimentally exposed to water that is both rapidly effective and does not require resorting to device disassembly. There further exists a need for such a composition and process for the use thereof that upon water displacement leaves a residual corrosion inhibitor to protect internal components of the device. Still further, there exists a need for such a composition and process for the use thereof that does not interfere with the functionality or appearance of the visual displays and touch screens associated with the subject device.

### SUMMARY OF THE INVENTION

A water displacing composition is provided that includes a C₄-C₉ hydrocarbon that is linear, branched or cyclic. The hydrocarbon represents the majority constituent of the composition. A C₃-C₈ alcohol is also present. The composition is well suited for displacing water from circuitry in a personal electronic device that has been inadvertently wet. An anti-corrosion agent can be provided to inhibit corrosion associated with residual water remaining in contact with the circuitry after exposure to the composition.

The process for restoring operation to a personal electronic device having circuitry that has been wet by water includes exposing the circuitry to the composition through spraying, immersion, or other techniques and then allowing sufficient time for the water to be displaced from the circuitry and the composition to evaporate. Typical times for the composition to evaporate and restore function to the personal electronic device range from 5 to 30 minutes followed by a 24 to 48 hour period, during which the device remains fully functional, before the visual display is clear of residual water-displacing composition.

### DETAILED DESCRIPTION OF THE PREFERRED EMBODIMENTS

The present invention has utility as a composition for the restoration of function and the maintenance thereof for a portable microelectronic device that has been exposed to inadvertent moisture ingress. As a result, an inventive composition rapidly restores functionality to a water exposed microelectronic device without resort to disassembly of device components. An inventive composition is readily applied to a microelectronic device user through resort to a conventional trigger spray applicator, propellant aerosol, a dip bath, or a cloth for wipe application onto and into recesses of the device.

Microelectronic devices that have been inadvertently exposed to moisture and as a result benefit from restoration through contact with an inventive composition illustratively include cellular telephones, computers, tablet computers, e-readers, pagers, flash drives, digital cameras, digital camcorders, dictation devices, insulin pumps, Holter monitors, global positioning satellite system receivers and personal entertainment (i.e. DVD) playback devices. Removal of a battery cover and battery and otherwise opening a device housing are not considered device disassembly in the context of the present invention.

An inventive composition includes C₄-C₉ hydrocarbon that is either ethylenically saturated or unsaturated. The hydrocarbon being linear, iso-, branched-, and cyclic-forms thereof, or combinations thereof. It is appreciated that with increasing molecular weight and linearity that the vapor pressure for a given water displacing hydrocarbon decreases according to well established principles. Selection of a suitable hydrocarbon from among those operative in the present invention is based upon factors including hydrocarbon viscosity, volatility, device material composition, device crevice dimensions, solubility of other inventive composition components therein, and miscibility with other composition components. It is appreciated that a hydrocarbon that forms an azeotrope with water or a combination of hydrocarbons that forms an azeotrope are also operative in driving water displacement away from surfaces of the microelectronic device.

The hydrocarbon is the majority component of an inventive composition. Preferably, the hydrocarbon represents more than 60% by weight of an inventive composition and more preferably in combination with a hydrotreated petroleum distillate represents more than 80 total weight percent of an inventive composition, and preferably more than 90 weight percent.

An inventive composition also includes a C₃-C₈ alcohol. The alcohol being iso-, branched, cyclic-forms thereof, or combinations of alcohols. Additionally it is appreciated that the alcohol is either saturated or unsaturated with the proviso that an ethylenically unsaturation is displaced by at least two carbon atoms relative to the alcohol hydroxyl moiety. Specific alcohols operative herein illustratively include isopropanol, butanol, isopentanol, hexanol, cyclohexanol, isohexanol, and combinations thereof. An alcohol is present in an inventive composition from between 2 and 49 total weight percent of the composition. It is appreciated that the inclusion of at least a portion of nonlinear alcohol is preferred. Without intending to be bound to a particular theory, it is believed that depending on concentration and identity of the alcohol, a clathrate is formed around water with an oriented layer or inverse micelle formed around water with the hydrocarbon representing the bulk phase, to lift or otherwise transport water from contact with device surfaces. The hydrocarbon phase is chosen to be hydrophobic and therefore largely immiscible with water and having only a limited, or no ability to swell or otherwise damage polymeric substances present within a microelectronic device. It is appreciated that an ethylenically unsaturated and alkyne hydrocarbon can be induced to undergo a hydration reaction according to conventional chemistry to form alcohols or aldehydes and thereby remove the water through reaction as well as displacement. An inventive composition including only the hydrocarbon and alcohol components is operative to rapidly displace water from within a microelectronic device. The process of restoring a wet device normally includes turning the device to an off-position and optionally removing various housing covers and batteries and peripherals associated with the device. Preferably, the device is then rinsed in deionized water, tap water, or hypotonic aqueous solution to reduce the amount of debris and or solutes within the device. An inventive composition is then liberally applied to the device, regardless of the status as to covers and peripherals. A composition storage housing is used such as an aerosol spray container, a trigger or pump spray, a pressurized spray device or simply through immersion in a bath of the inventive composition. With interior surfaces of the device wet by the inventive composition, the device is air dried to displace water and remove the same from the device. Optionally, drying is facilitated by resort to a blower, vacuum draw, centrifugal force, and combinations thereof. The flammable nature of the inventive composition should be considered prior to exposing a treated device to contact with a heat source or electrical spark or usage in a poorly ventilated area.

An inventive composition optionally includes a halocarbon or hydrocarbon propellant in instances when an aerosol delivery system of an inventive composition is desired. Aerosol propellants operative herein illustratively include difluoroethane, trifluoroethane; alkanes such as butane, pentane, isobutane; propane; ethers such as dimethyl ether and diethyl ether; nitrogen; carbon dioxide; and combinations thereof. The resultant formulation inclusive of a propellant is sealed within a conventional metal aerosol canister and applied by spray application as is conventional to the art. It is appreciated that many of these propellants operate synergetically with an inventive composition to displace water.

In addition to the hydrocarbon and alcohol components in an inventive composition, optionally, an inventive composition includes other hydrophobic optional solvents operative in inventive composition that illustratively include hydrofleuoroether, C₁-C₆ fluorocarbons, C₂-C₄ chlorocarbons, and C₃-C₆ alkylbromides. Typically, each of these optional additional solvent components in an inventive composition is present from 0 to 30 total weight percent with accumulative amount of optional additional solvents being less than 47 total weight percent.

In order to inhibit corrosion associated with residual water left within the device after treatment with an inventive composition, the inventive composition optionally has dissolved therein one or more corrosion inhibitor compounds, water sequestering additives, or a combination thereof.

The water displacing solvent components of an inventive composition are selected to be compatible with a polar corrosion inhibitor. A corrosion inhibitor if present, preferably has limited volatility below 120° C. Corrosion inhibitors operative herein illustratively include nonionic surfactants such as ethoxylated aliphatic alcohols, polyoxyethylene surfactants, carboxylic esters, polyethylene glycol esters and anhydrosorbitol ester; dimerized unsaturated fatty acids such as a stearic acid dimer; fatty acid trimers having an average of between C₃₀ and C₉₀ in the molecule; and various fatty acids such as oleic acid, phenyl undecylic acid, phenyl stearic acid, xylyl stearic acid, xenyl stearic acid, dodecyl phenyl stearic acid, naphthenic acid, sorbitan monooleate, mannitan monooleate, sorbitan dilaurate, sorbitan triricinoleate, diglycol laurate, diglycol ricinoleate, diethyleneglycol monolaurate, glyeryl monooleate, glyceryl dioleate, zinc phenylundecanoate, zinc ethyl phenyl stearate, magnesium phenyl stearate, calcium xenyl stearate, sodium petroleum sulfonate, barium petroleum sulfonate dodecyl ammonium laurate, cyclohexyl ammonium laurate, dicyclohexyl ammonium laurate, sulfonates such as alkali metal and alkali earth sulfonates, of the structure [RSO₂—O⁻]ₓY^{x+} where R is C₁-C₂₀ alkyl, C₆-C₁₂ aryl, C₁-C₂₀ alkyl having a pendent C₆-C₁₂ aryl; and C₆-C₁₂ having a pendent C₁-C₂₀ alkyl, where x is an integer value of between 1 and 3 inclusive, and Y is an alkali metal cation, an alkali earth cation, or a C₁-C₂₀ alkyl or alkylene ester moiety with the appreciation that when Y is an ester moiety X is one. A corrosion inhibitor, when present is typically present as an individual compound or combination of multiple such compounds from 0 to 25 total weight percent. Preferably, corrosion inhibitors are present from 1 to 10 total weight percent of an inventive composition.

Optionally, an inventive composition includes a nanoparticulate sized powdered zeolite such as ZSM-5 capable of absorbing trace quantities of water not otherwise displaced by solvents of inventive composition. Said zeolites if present, are ground to a mean maximal linear extent particle size of between 1 to 100 nanometers. Zeolites are present from 0-3 total weight percent. It is appreciated that a zeolite component in addition to facilitating sequestration of residual water within a device also serves to enhance storage stability of an inventive composition. (Zeolite) “Clinoptilolite can be ground by a certain tribomechanical processing in a patented machine (patent: PCT/1B99/00757) yielding particles on a submicron level (micro and nonparticles)”. An inventive composition optionally contains one or more additives from among fragrances, antioxidants, UV stabilizers, processing additives, and combinations thereof. Such optional additives are present in amounts conventional to the art and typically are in amounts from 0 to 1 total weight percent for each such optional additive.

An inventive composition is readily provided in a container for application to a water damaged personal electronic device through resort to a conventional trigger- or pump-spray applicator, propellant aerosol, or immersion bath into which the device is placed and then removed after allowing sufficient time for composition penetration.

Typical and preferred compositions according to the present invention are provided in Table 1.

TABLE 1
Inventive Composition (amounts in total weight percent exclusive
of optional propellant)

| Ingredient | Typical | Preferred |
|---|---|---|
| C₄-C₉ hydrocarbon | 51-98 | 60-95 |
| C₃-C₈ alcohol | 2-49 | 10-30 |
| Hydrofluorocarbon | 0-25 | 1-10 |
| Corrosion inhibitor | 0-25 | 1-10 |
| Zeolite | 0-3 | 0.05-1 |
| Fragrance | 0-1 | 0.01-0.5 |
| Antioxidant | 0-1 | 0.01-0.5 |
| UV stabilizer | 0-1 | 0.01-0.5 |

The present invention is further detailed with respect to the following non-limiting examples that are provided to further illustrate the preparation of invention compositions and the operational attributes associated with treatment of water damaged personal electronic devices upon interaction with an inventive composition.

### EXAMPLE 1

A composition is prepared including 80 weight percent isohexane, 16 weight percent isopropanol and 4 weight percent hydrotreated light petroleum distillates. A cellular telephone in an on-position is immersed in tap water for 30 seconds to one hour, the backing is then removed as well as the battery. The exposed components of the cellular telephone are filled with the above composition through spray addition until excess liquid begins to pool in the battery compartment. The inventive composition is allowed to evaporate. With confirmation of battery charge, the cellular telephone battery and cover are reinstalled and operated normally. Cellular telephone function is restored and maintained.

### EXAMPLE 2

The composition of Example 1 is modified with 0.5 total weight percent of sorbitan trioleate additives, along with 0.3 total weight percent of calcium sulfonate and a proportional decrease in the amount of isohexene. The resulting composition is tested per Example 1 and with a single treatment of the cellular telephone immersed per Example 1, restores long term function thereto.

### EXAMPLE 3

The composition of Example 2 is modified to include 0.3 total weight percent unsaturated C₁₈ fatty acid dimers with a proportional decrease in the amount of isohexene. The resulting composition is loaded into an aerosol canister using carbon dioxide as a propellant. The composition is spray applied to a cellular telephone soaked per Example 1 and restores function thereto after a single application.

### EXAMPLE 4

The composition of Example 1 is modified with 0.5% of ZSM-5 zeolite and a proportional decrease in the amount of isohexene. A cellular telephone in an on-position is immersed in an everyday aqueous based solution for 30 seconds to one hour. The device is retrieved from the aqueous solution, the backing is removed as well as the battery, and the device is thoroughly rinsed with preferably de-ionized or distilled water, or minimally, clear tap water to remove suspended or dissolved material from the device. The exposed components of the cellular telephone are then filled with the above composition through spray addition until excess liquid begins to pool in the battery compartment. The inventive composition is allowed to evaporate. With confirmation of battery charge, the cellular telephone battery and cover are reinstalled and operated normally. Cellular telephone function is restored and maintained.

Patents and publications mention the specification are indicative of the levels of those skilled in the art to which the invention pertains. These patents and publications are incorporated herein by reference to the same extent as if each individual patent or publication was specifically and individually incorporated herein by reference.

The forgoing description is illustrative of particular embodiments of the invention, but is not meant to be a limitation upon the practice thereof. The following claims, including all equivalents thereof are intended to define the scope of the invention.

1. A water displacing composition comprising:
a C₄-C₉ hydrocarbon, said hydrocarbon being linear, branched or cyclic and being a majority constituent by weight; and
a C₃-C₆ alcohol.

2. The composition of claim 1 wherein said hydrocarbon is ethylenically saturated.

3. The composition of claim 1 wherein said hydrocarbon is branched.

4. The composition of claim 1 wherein said alcohol is branched.

5. The composition of claim 1 wherein said alcohol is isopropanol.

6. The composition of claim 1 wherein the composition is anhydrous.

7. The composition of claim 1 further comprising an anti-corrosion agent.

8. The composition of claim 7 wherein said anti-corrosion agent is at least one of: a nonionic surfactant, a dimerized unsaturated fatty acid, a fatty acid trimer, and a fatty acid, and a fatty acid ester.

9. The composition of claim 7 wherein said anti-corrosion agent comprises a sulfonate.

10. The composition of claim 7 wherein said anti-corrosion agent comprises a fatty acid dimer.

11. The composition of claim 1 further comprising a water sequestering zeolite.

12. The composition of claim 1 further comprising an aerosol propellant.

13. A water displacing composition consisting essentially of:
C₄-C₉ hydrocarbon, said hydrocarbon being linear, branched or cyclic and being present from 51-98 total weight percent;
C₃-C₆ alcohol present from 2 to 49 total weight percent; and
optionally including at least one of: an anti-corrosion agent, a water sequestering substance, a fragrance, or an aerosol propellant.

14. The composition of claim 13 wherein the composition is anhydrous.

15. The composition of claim 13 wherein said hydrocarbon is ethylenically saturated.

16. The composition of claim 13 wherein said hydrocarbon is branched.

17. The composition of claim 13 wherein said alcohol is branched.

18. The composition of claim 13 wherein said alcohol is isopropanol.

19. A process for restoring operation of a personal electronic device having wet circuitry, the process comprising:
exposing the circuitry to a composition comprising: a C₄-C₉ hydrocarbon, said hydrocarbon being linear, branched or cyclic and being a majority constituent by weight; and a C₃-C₆ alcohol; and
allowing sufficient time for the water to be displaced from the circuitry to restore operation to the personal electronic device.

20. The process of claim 19 further comprising re-exposing the circuitry to the composition.

21. The process of claim 19 wherein the exposing step is spraying.

22. The process of claim 19 wherein the exposing step is immersing.

23. The process of claim 19 wherein the time for the water to be displaced is from 5 to 30 minutes.

24. The process of claim 19 further comprising rinsing the personal electronic device with at least one of tap water, deionized water, or a hypotonic solution prior to the exposing step.
